(19) United States
(12) Patent Application Publication
(10) Pub. No.: US 2019/0308516 A1
(43) Pub. Date: Oct. 10, 2019

(54) DEVICE FOR INDUCTIVELY CHARGING AN ELECTRIC VEHICLE, AND METHOD FOR DETECTING ELECTRICALLY CONDUCTIVE FOREIGN BODIES IN SUCH A DEVICE

(71) Applicant: Robert Bosch GmbH, Stuttgart (DE)

(72) Inventors: Moritz Braeuchle, Walddorfhaeslach (DE); Gabriel Krein, Neckarzimmern (DE); Philipp Schumann, Stuttgart (DE)

(21) Appl. No.: 16/461,034

(22) PCT Filed: Oct. 4, 2017
(86) PCT No.: PCT/EP2017/075131

§ 371 Date: May 15, 2019

(30) Foreign Application Priority Data
Nov. 16, 2016 (DE) 10 2016 222 554.5

(51) Int. Cl. B60L 53/124; H02J 50/60; H02J 7/02; H02J 50/10

(52) U.S. Cl. CPC B60L 53/124; H02J 50/10; H02J 7/025; H02J 50/60

(57) ABSTRACT

The invention relates to a device for inductively charging an electric vehicle (17), comprising a primary coil (11) for generating a main magnetic field (10) and a sensor coil system (30) for detecting electrically conductive foreign bodies, having at least one sensor coil. The sensor coils are arranged and connected relative to the primary coil (11) such that no voltages are induced by the main magnetic field (10) if interference magnetic fields generated by foreign bodies are absent in the sensor coil system (30), and a voltage is induced by the main magnetic field (10) if an interference magnetic field generated by a foreign body is present in the sensor coil system (30). The invention also relates to a method for detecting electrically conductive foreign bodies in a device according to the invention, wherein a main magnetic field (10) is generated by means of the primary coil (11), a voltage induced in the sensor coil system (30) by the main magnetic field (10) is measured, and an electrically conductive foreign body is detected if the measured voltage exceeds a specified threshold.

### BACKGROUND OF THE INVENTION

The invention relates to a device for inductively charging an electric vehicle, comprising a primary coil for generating a main magnetic field and a sensor coil system for detecting electrically conductive foreign bodies, said sensor coil system having at least one sensor coil. The invention also relates to a method for detecting electrically conductive foreign bodies in a device according to the invention.

Electric vehicles generally have an electrical energy store, for example a traction battery, which can store electrical energy for the drive. If this electrical energy store is entirely or partially discharged, the electrical energy store can be charged again at a corresponding charging station. For this purpose, charging stations are known in which the electrical energy is transmitted to the electrical energy store by means of a charging cable.

Charging stations are also known in which the electrical energy is transmitted to the electrical energy store of the electric vehicle inductively by means of a magnetic field, i.e. without the use of cables. Such a charging station comprises a primary coil which is in the form of a charging plate placed on the ground, for example. The electric vehicle has a secondary coil, which is fitted to an underbody of the electric vehicle. There is an air gap between the primary coil and the secondary coil. In order to transmit energy, a magnetic field is generated by means of the primary coil, and this magnetic field passes through the secondary coil and induces a corresponding current there. The magnetic field is in this case generated at a frequency of several kHz.

If there are metallic foreign bodies in the air gap between the primary coil and the secondary coil, electrical eddy currents can be induced in these foreign bodies. As a result, the foreign bodies can be heated to a considerable extent. This firstly causes power losses during charging of the electrical energy store and also poses a risk to humans and the environment. Therefore, it is necessary for safe operation of the charging station to identify any metallic foreign bodies.

DE 10 2013 223 794 A1 discloses an inductive energy transmission system and a method for identifying foreign objects in the inductive energy transmission system. For this purpose, the energy transmission system comprises a metal detector, which can detect metallic foreign objects by means of additional test coils.

DE 10 2013 219 678 A1 also discloses a method and a device for determining a foreign object. In this case, a capacitance element is connected to a coil and a magnetic field is generated. In this case, the frequency of the magnetic field is varied and a measurement curve which is recorded is compared with a reference profile.

### SUMMARY OF THE INVENTION

A device for inductively charging an electric vehicle is proposed which comprises a primary coil for generating a main magnetic field and a sensor coil system for detecting electrically conductive foreign bodies. The sensor coil system in this case has at least one sensor coil.

An alternating current with a main frequency flows through the primary coil, and the main magnetic field is therefore an alternating magnetic field with the same main frequency. The primary coil is circular, for example, and generates a main magnetic field which passes into a secondary coil, which is fitted to an underbody of the electric vehicle.

In accordance with the invention, the sensor coils of the sensor coil system are arranged relative to the primary coil and interconnected in such a way that in the event of the absence of magnetic interference fields generated by foreign bodies, no voltage is induced by the main magnetic field in the sensor coil system, and that in the event of the presence of a magnetic interference field generated by a foreign body, a voltage is induced by the main magnetic field in the sensor coil system.

The sensor coil system is arranged in such a way that, if appropriate, voltage components are induced in the individual sensor coils by field components of the main magnetic field. However, the sensor coils are designed and interconnected in such a way that in the event of the absence of electrically conductive foreign bodies, the voltage components induced by the field components of the main magnetic field cancel one another out. Therefore, in theory, no voltage is measurable across the sensor coil system. In practice, a comparatively low voltage which is below a preset threshold value may be measurable.

In the event of the presence of an electrically conductive foreign body, the main magnetic field generates eddy currents in this foreign body which generate a magnetic interference field. The foreign body therefore generates a magnetic interference field which is superimposed on the main magnetic field and is in the opposite direction to the main magnetic field. As a result, the main magnetic field is weakened locally. In this case, the voltage components induced in the sensor coil system no longer cancel one another out. Therefore, a voltage which is above the preset threshold value is measurable across the sensor coil system.

In accordance with an advantageous configuration of the invention, the sensor coil system has a sensor coil, which is arranged in such a way that in the event of the absence of magnetic interference fields generated by foreign bodies, two field components of the main magnetic field with the same field strength and the opposite direction flow through the sensor coil. The two field components of the main magnetic field therefore induce two voltage components with the same magnitude and the opposite direction in the sensor coil, and these two voltage components cancel one another out. Therefore, in theory, no voltage is measurable across the sensor coil of the sensor coil system.

In accordance with another advantageous configuration of the invention, the sensor coil system has at least two sensor coils, which are arranged in such a way that in the event of the absence of magnetic interference fields generated by foreign bodies, the same field component of the main magnetic field flows through the at least two sensor coils. The field component of the main magnetic field therefore induces the same voltage component with the same magnitude in each sensor coil. The sensor coils are connected in series in such a way that the voltage components point in opposite directions and cancel one another out. Therefore, in theory, no voltage is measurable across the sensor coil system.

In accordance with a further advantageous configuration of the invention, the sensor coil system has at least two sensor coils, which are arranged in such a way that in the event of the absence of magnetic interference fields generated by foreign bodies, two field components of the main magnetic field with the same field strength and the opposite direction flow through the at least two sensor coils. The two field components of the main magnetic field therefore induce the same voltage component with the same magnitude in each sensor coil. The sensor coils are connected in series in such a way that the voltage components point in opposite directions and cancel one another out. Therefore, in theory, no voltage is measurable across the sensor coil system.

In accordance with a possible configuration of the invention, the sensor coil system has precisely two sensor coils, which are configured identically.

In accordance with an alternative configuration of the invention, the sensor coil system has at least two sensor coils, which are configured differently.

There are several degrees of freedom for the configuration and dimensioning of the sensor coils. In particular, the number of turns, the winding sense and the cross-sectional area of the individual sensor coils can be varied.

In accordance with an advantageous development of the invention, means for generating a sensor magnetic field by means of the sensor coil system and means for determining properties of the sensor coil system are provided in the device according to the invention. The means for generating a sensor magnetic field comprise in particular an alternating current source or an AC voltage source. The means for determining properties of the sensor coil system comprise, for example, measuring instruments for measuring current and voltage and a phase shift between the current and the voltage.

A method for detecting electrically conductive foreign bodies in a device according to the invention is also proposed. In this case, a main magnetic field for transmitting energy to the secondary coil on the underbody of the electric vehicle is generated in the device by means of the primary coil.

In accordance with the invention, in this case a voltage induced in the sensor coil system by the main magnetic field is measured. In this case, an electrically conductive foreign body is detected when the measured voltage exceeds a preset threshold value. In this case, it is concluded that a magnetic interference field generated by a foreign body is present and therefore that an electrically conductive foreign body is present.

In the event of the absence of magnetic interference fields generated by foreign bodies, as already mentioned, in theory no voltage is measurable across the sensor coil system.

In accordance with an advantageous development of the invention, a sensor magnetic field is generated by means of the sensor coil system, and properties of the sensor coil system are determined. The determination of properties of the sensor coil system provides an additional possible way of detecting electrically conductive foreign bodies in the device according to the invention which is independent of the main magnetic field.

Preferably, in this case an impedance, an inductance, a nonreactive resistance and/or a Q factor of the sensor coil system are determined. In this case, for example, current and voltage and a phase shift between the current and the voltage of the sensor coil system are measured. The desired variables of impedance, inductance, nonreactive resistance and Q factor of the sensor coil system can be determined computationally from the measured values.

Preferably, the sensor magnetic field in this case has a sensor frequency which deviates from the main frequency of the main magnetic field. As a result, the determination of the properties of the sensor coil system is independent of the main magnetic field.

The device according to the invention for inductively charging an electric vehicle and the method according to the invention permit comparatively simple detection of electrically conductive foreign bodies in the device. In particular, it is not necessary to record families of characteristics of the main magnetic field for different operational cases and to adjust a voltage present across the sensor coil system to the families of characteristics. Therefore, passive detection of foreign bodies during inductive charging of the electric vehicle by means of a simple measurement of a voltage which is induced by the main magnetic field is made possible.

In addition, active detection of foreign bodies by virtue of the generation of a sensor magnetic field by means of the sensor coil system and determination of properties of the sensor coil system is made possible. Said active detection is in this case independent of the main magnetic field and can be performed before the main magnetic field is generated, for example shortly prior to the beginning of a charging operation. The active detection can also take place at the same time as the inductive charging of the electric vehicle. The main magnetic field does not induce any interference voltages which influence the means for determining properties of the sensor coil system. In particular, decoupling of the main magnetic field and the sensor magnetic field is possible when both magnetic fields have different frequencies.

It is also possible for ferritic foreign bodies to be detected by means of the device according to the invention and by the method according to the invention. Ferritic foreign bodies in this case cause local intensification and local weakening of the main magnetic field.

### BRIEF DESCRIPTION OF THE DRAWINGS

Embodiments of the invention will be explained in more detail with reference to the drawings and the description below.

In the drawings:

FIG. 1 shows a schematic illustration of an electric vehicle and a device for inductively charging the electric vehicle,

FIG. 2 shows a schematic plan view of a main magnetic field of a device in accordance with a first embodiment,

FIG. 3 shows a schematic plan view of a main magnetic field of a device in accordance with a second embodiment,

FIG. 4 shows a schematic plan view of a main magnetic field of a device in accordance with a third embodiment,

FIG. 5 shows a schematic plan view of a main magnetic field of a device in accordance with a fourth embodiment, and

FIG. 6 shows a schematic plan view of a main magnetic field of a device in accordance with a fifth embodiment.

### DETAILED DESCRIPTION

In the description below relating to the embodiments of the invention, identical or similar elements have been provided with the same reference symbols, with no repeated description of these elements being provided in individual cases. The figures are purely schematic representations of the subject matter of the invention.

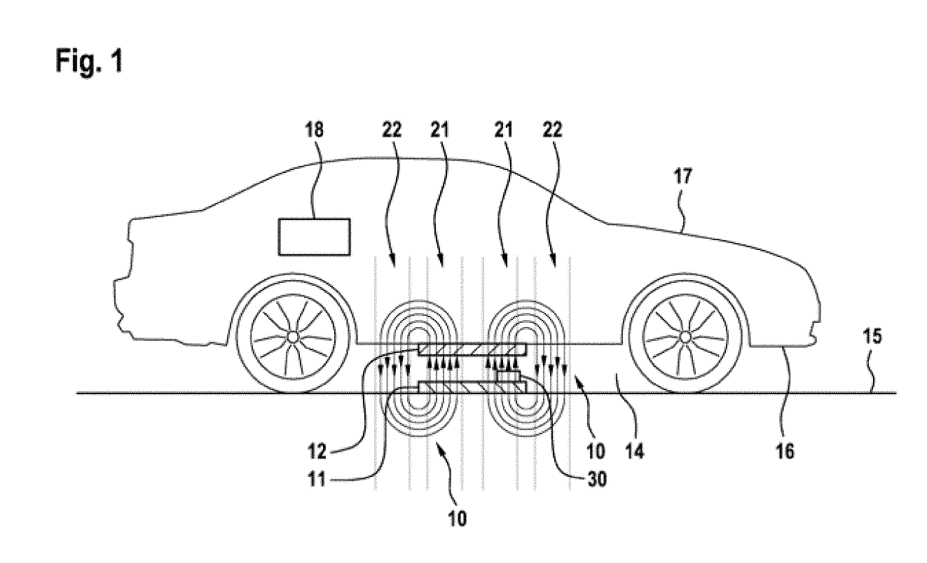

FIG. 1 illustrates schematically an electric vehicle 17 which is parked up over a device for inductively charging the electric vehicle 17. Such a device is also referred to as an inductive charging station. The device for inductively charging the electric vehicle 17 is located on the ground 15 beneath the electric vehicle 17 and comprises a primary coil 11 for generating a main magnetic field 10.

A secondary coil 12 is fitted to an underbody 16 of the electric vehicle 17. The electric vehicle 17 is presently parked up in such a way that, as far as possible, the secondary coil 12 is arranged over the primary coil 11. The main magnetic field 10 generated by the primary coil 11 therefore passes through the secondary coil 12, as a result of which energy is transmitted inductively from the primary coil 11 to the secondary coil 12 of the electric vehicle 17. The secondary coil 12 draws the energy transmitted by the primary coil 11 and charges a traction battery 18 of the electric vehicle 17.

Owing to the required ground clearance of the electric vehicle 17, there is an interspace 14 between the ground 15 and the underbody 16 of the electric vehicle 17, with this interspace having an air gap of several centimeters. The interspace 14 with the air gap also extends between the primary coil 11 and the secondary coil 12. The primary coil 11 and the secondary coil 12 are therefore arranged spaced apart from one another.

The device for inductively charging the electric vehicle 17 also comprises a sensor coil system 30 for detecting electrically conductive foreign bodies which may be located in the interspace 14 between the primary coil 11 and the secondary coil 12. The sensor coil system 30 in this case has one or more sensor coils 31, 32, 33, which in this case are arranged on the primary coil 11 and in the interspace 14.

The primary coil 11 is in this case approximately in the form of a ring coil or circular coil. In the illustration shown here, the main magnetic field 10 is depicted by marked lines of force. The lines of force of the main magnetic field 10 generated by the primary coil 11 in this case pass through the primary coil 11 and the secondary coil 12 and close again outside the primary coil 11 and the secondary coil 12.

An alternating current with a main frequency flows through the primary coil 11, and the main magnetic field 10 is therefore an alternating magnetic field with the same main frequency of 85 kHz, for example. In the illustration shown, the main magnetic field 10 is shown at a defined point in time, i.e. statically.

In this case, the main magnetic field 10 comprises a first field component 21, in which the lines of force of the main magnetic field 10 run approximately perpendicularly from the ground 15 to the underbody 16 of the electric vehicle 17, i.e. upwards. In addition, the main magnetic field 10 comprises a second field component 22, in which the lines of force of the main magnetic field 10 run approximately perpendicularly from the underbody 16 of the electric vehicle 17 to the ground 15, i.e. downwards. Irrespective of the illustration shown here, the two field components 21, 22 of the main magnetic field 10 point in the opposite direction from one another and have an identical field strength at any point in time.

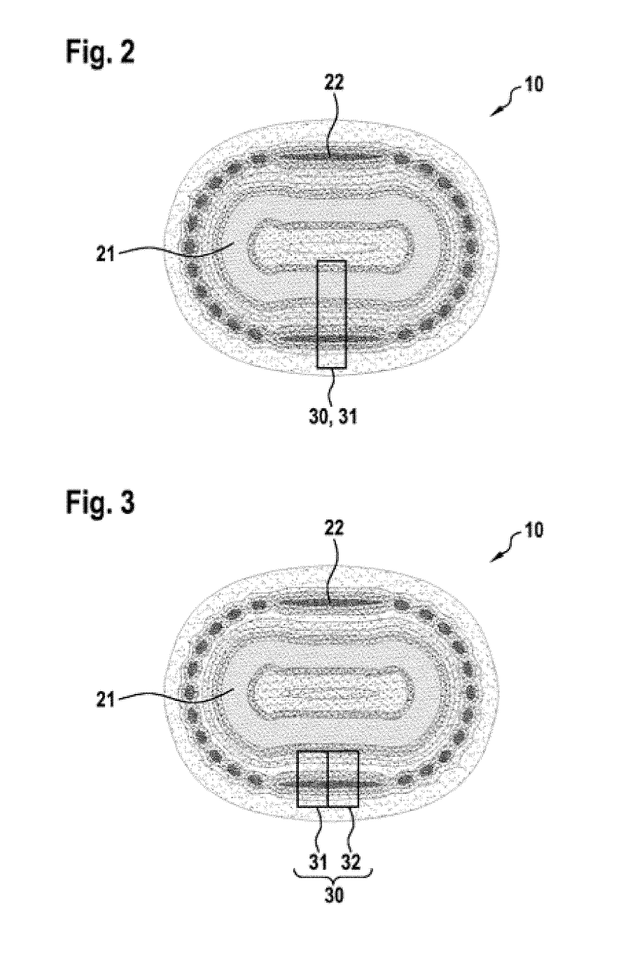

FIG. 2 shows a schematic plan view of the main magnetic field 10 of a device in accordance with a first embodiment. The sensor coil system 30 has a first sensor coil 31, which is arranged in such a way that the first field component 21 and the second field component 22 flow uniformly through the first sensor coil 31.

The first field component 21 and the second field component 22 therefore induce two voltage components with the same magnitude and the opposite direction in the first sensor coil 31, and these two voltage components cancel one another out. Therefore, in theory, no voltage is measurable across the first sensor coil 31 of the sensor coil system 30.

FIG. 3 shows a schematic plan view of the main magnetic field 10 of a device in accordance with a second embodiment. The sensor coil system 30 has a first sensor coil 31 and a second sensor coil 32, which are arranged in such a way that the second field component 22 flows through the first sensor coil 31 and the second sensor coil 32. The first sensor coil 31 and the second sensor coil 32 are constructed identically and in particular have the same number of turns and the same cross-sectional area.

The second field component 22 therefore induces the same voltage component with the same magnitude in the first sensor coil 31 and in the second sensor coil 32. The first sensor coil 31 and the second sensor coil 32 are connected in series in such a way that the voltage components point in opposite directions and cancel one another out. Therefore, in theory, no voltage is measurable across the sensor coil system 30.

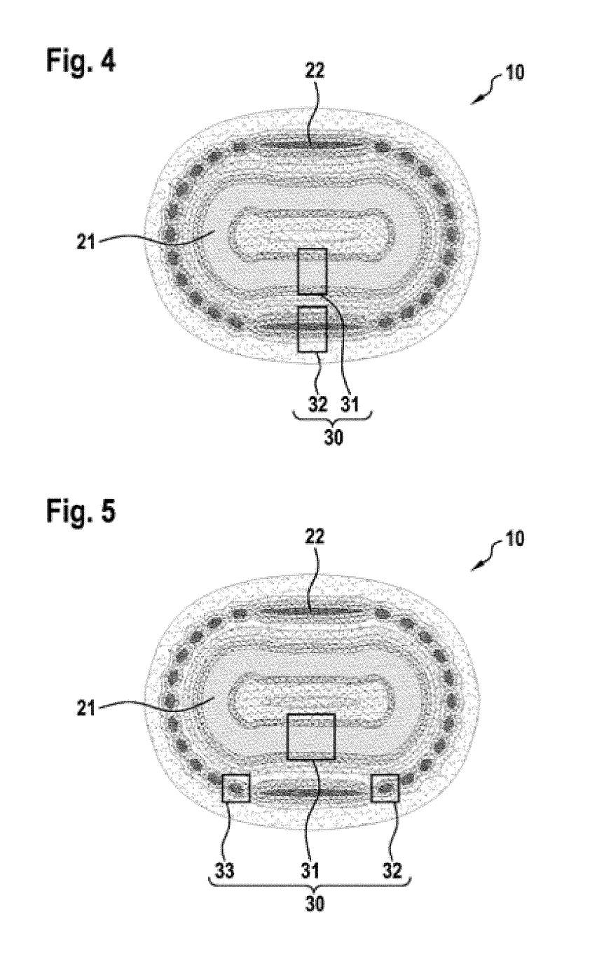

FIG. 4 shows a schematic plan view of the main magnetic field 10 of a device in accordance with a third embodiment. The sensor coil system 30 has a first sensor coil 31 and a second sensor coil 32, which are arranged in such a way that the first field component 21 flows through the first sensor coil 31, and the second field component 22 flows through the second sensor coil 32. The first sensor coil 31 and the second sensor coil 32 are constructed identically and in particular have the same number of turns and the same cross-sectional area.

The first field component 21 and the second field component 22 therefore induce the same voltage component with the same magnitude in the first sensor coil 31 and in the second sensor coil 32. The first sensor coil 31 and the second sensor coil 32 are connected in series in such a way that the voltage components point in opposite directions and cancel one another out. Therefore, in theory, no voltage is measurable across the sensor coil system 30.

FIG. 5 shows a schematic plan view of the main magnetic field 10 of a device in accordance with a fourth embodiment. The sensor coil system 30 has a first sensor coil 31, a second sensor coil 32 and a third sensor coil 33, which are arranged in such a way that the first field component 21 flows through the first sensor coil 31, and the second field component 22 flows through the second sensor coil 32 and the third sensor coil 33. The second sensor coil 32 and the third sensor coil 33 are constructed identically and in particular have the same number of turns and the same cross-sectional area. The first sensor coil 31 is constructed differently from this and in particular has twice as many turns as the second sensor coil 32 and the third sensor coil 33.

In this case, the first field component 21 induces a voltage component in the first sensor coil 31. The second field component 22 induces the same voltage component with the same magnitude in the second sensor coil 32 and in the third sensor coil 33, which are connected in series. The first sensor coil 31 is connected in series with the second sensor coil 32 and with the third sensor coil 33 in such a way that the voltage components point in opposite directions and cancel one another out. Therefore, in theory, no voltage is measurable across the sensor coil system 30.

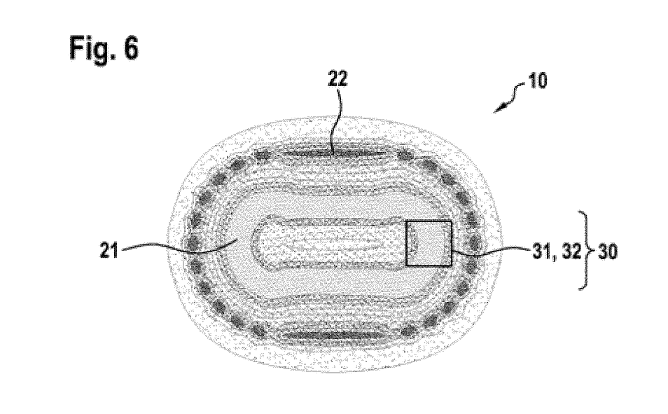

FIG. 6 shows a schematic plan view of the main magnetic field 10 of a device in accordance with a fifth embodiment. The sensor coil system 30 has a first sensor coil 31 and a second sensor coil 32, which are arranged in such a way that the first field component 21 flows through the first sensor coil 31 and the second sensor coil 32. In this case, the first sensor coil 31 and the second sensor coil 32 are arranged concentrically one above the other. The first sensor coil 31 and the second sensor coil 32 are constructed identically and in particular have the same number of turns and the same cross-sectional area. The turns of the first sensor coil 31 and the second sensor coil 32 have a different winding sense, however.

The first field component 21 therefore induces the same voltage component with the same magnitude in the first sensor coil 31 and in the second sensor coil 32. The first sensor coil 31 and the second sensor coil 32 are connected in series in such a way that the voltage components point in opposite directions and cancel one another out. Therefore, in theory, no voltage is measurable across the sensor coil system 30.

The invention it is not restricted to the exemplary embodiments described herein and the aspects raised in these exemplary embodiments. Instead, a multiplicity of modifications within the scope of the practice of a person skilled in the art are possible within the scope specified in the claims.

1. A device for inductively charging an electric vehicle (17), comprising
a primary coil (11) for generating a main magnetic field (10) and a sensor coil system (30) for detecting electrically conductive foreign bodies, said sensor coil system having at least one sensor coil (31, 32, 33),
characterized in that
the sensor coils (31, 32, 33) are arranged relative to the primary coil (11) and interconnected in such a way that
in the event of the absence of magnetic interference fields generated by foreign bodies, no voltage is induced by the main magnetic field (10) in the sensor coil system (30), and that
in the event of the presence of a magnetic interference field generated by a foreign body,
a voltage is induced by the main magnetic field (10) in the sensor coil system (30).

2. The device as claimed in claim 1, characterized in that
the sensor coil system (30) has a sensor coil (31), which is arranged in such a way that
in the event of the absence of magnetic interference fields generated by foreign bodies, two field components (21, 22) of the main magnetic field (10) with the same field strength and the opposite direction flow through the sensor coil (31).

3. The device as claimed in claim 1, characterized in that
the sensor coil system (30) has at least two sensor coils (31, 32), which are arranged in such a way that
in the event of the absence of magnetic interference fields generated by foreign bodies, the same field component (21, 22) of the main magnetic field (10) flows through the at least two sensor coils (31, 32).

4. The device as claimed in claim 1, characterized in that
the sensor coil system (30) has at least two sensor coils (31, 32), which are arranged in such a way that
in the event of the absence of magnetic interference fields generated by foreign bodies, two field components (21, 22) of the main magnetic field (10) with the same field strength and the opposite direction flow through the at least two sensor coils (31, 32).

5. The device as claimed in claim 3, characterized in that
the sensor coil system (30) has precisely two sensor coils (31, 32), which are configured identically.

6. The device as claimed in claim 3, characterized in that
the sensor coil system (30) has at least two sensor coils (31, 32), which are configured differently.

7. The device as claimed in claim 1, further comprising
a sensor magnetic field generator of the sensor coil system (30) and
a device-determining properties of the sensor coil system (30).

8. A method for detecting electrically conductive foreign bodies in a device as claimed in claim 1, wherein a main magnetic field (10) is generated by the primary coil (11),
characterized in that
a voltage induced in the sensor coil system (30) by the main magnetic field (10) is measured, and in that
an electrically conductive foreign body is detected when the measured voltage exceeds a preset threshold value.

9. The method as claimed in claim 8, characterized in that
a sensor magnetic field is generated by the sensor coil system (30), and in that properties of the sensor coil system (30) are determined.

10. The method as claimed in claim 9, characterized in that
an impedance, an inductance, a resistance and/or a Q factor of the sensor coil system (30) are determined.

11. The method as claimed in claim 9, characterized in that
the sensor magnetic field has a sensor frequency which deviates from the main frequency of the main magnetic field (10).
